(19) United States
(12) Patent Application Publication
(10) Pub. No.: US 2020/0210688 A1
(43) Pub. Date: Jul. 2, 2020

(54) IMAGE DATA PROCESSING SYSTEM AND METHOD

(71) Applicant: Hu Man Ren Gong Zhi Neng Ke Ji (Shanghai) Limited, Shanghai (CN)

(72) Inventor: Yi XU, London (GB)

(21) Appl. No.: 16/642,692

(22) PCT Filed: Aug. 3, 2018
(86) PCT No.: PCT/CN2018/098438

§ 371 Date: Feb. 27, 2020

(30) Foreign Application Priority Data
Aug. 29, 2017 (GB) 1713829.8

(51) Int. Cl. G06K 9/00; G06K 9/62; G06N 3/08

(52) U.S. Cl. CPC G06K 9/00302; G06K 9/00268; G06N 3/08; G06K 9/6232; G06K 9/00335

(57) ABSTRACT

A method of recognising human characteristics from image data of a subject. The method comprises extracting a sequence of images of the subject from the image data; from each image estimating an emotion feature metric and a facial mid-level feature metric for the subject; for each image, combining the associated estimated emotion metric and estimated facial mid-level feature metric to form a feature vector, thereby forming a sequence of feature vectors, each feature vector associated with an image of the sequence of images, and inputting the sequence of feature vectors to a human characteristic recognising neural network. The human characteristic recognising neural network is adapted to process the sequence of feature vectors and generate output data corresponding to at least one human characteristic derived from the sequence of feature vectors.

### CROSS-REFERENCE TO RELATED APPLICATIONS

The present application is a U.S. National Phase Entry of International PCT Application No. PCT/CN2018/098438 having an international filing date of Aug. 3, 2018, which claims priority to British Patent Application No. GB1713829.8 filed on Aug. 29, 2017. The present application claims priority and the benefit of the above-identified applications and the above-identified applications are incorporated by reference herein in their entirety.

### TECHNICAL FIELD

The present disclosure relates to methods and systems for recognising human characteristics from image data of a subject. More specifically, but not exclusively, embodiments of the disclosure relate to recognising human characteristics from video data comprising facial images of a human face.

### BACKGROUND

Techniques for processing image data of subjects, such as humans, to attempt to determine further information about the subjects are well known. For example, facial recognition techniques are widely known for use in identifying subjects appearing in images, for example for determining the identity of a person appearing in video footage.

Recently, more advanced techniques have been developed which attempt to identify more nuanced information about the subject of an image beyond their identity. For example, algorithms have been developed which attempt to identify, from facial image data, information about the immediate emotional state of the subject. Such techniques often employ artificial neural networks, and specifically convolutional neural networks (CNNs). Such CNNs are “trained” using pre-selected images of human subjects who are classified as demonstrating in the image data facial expressions associated with particular predefined emotions.

Whilst such techniques can demonstrate success in identifying immediate and obvious “reflex” emotions such as anger, contempt, disgust, fear, happiness, sadness and surprise, little development has been undertaken to explore techniques which reliably identify more subtle information about a person, for example characteristics (i.e. personality traits) such as confidence, honesty, nervousness, curiosity, judgment and disagreement.

### SUMMARY

In accordance with a first aspect of the disclosure, there is provided a method of recognising human characteristics from image data of a subject. The method comprises extracting a sequence of images of the subject from the image data; from each image estimating an emotion feature metric and a facial mid-level feature metric for the subject; for each image, combining the associated estimated emotion metric and estimated facial mid-level feature metric to form a feature vector, thereby forming a sequence of feature vectors, each feature vector associated with an image of the sequence of images, and inputting the sequence of feature vectors to a human characteristic recognising neural network. The human characteristic recognising neural network is adapted to process the sequence of feature vectors and generate output data corresponding to at least one human characteristic derived from the sequence of feature vectors.

Optionally, the image data is video data.

Optionally, the extracted sequence of images are facial images of a face of the subject.

Optionally, the face of the subject is a human face.

Optionally, the emotion metric is estimated by an emotion recognising neural network trained to recognise a plurality of predetermined emotions from images of human faces.

Optionally, the emotion metric is associated with a human emotion of one or more of anger, contempt, disgust, fear, happiness, sadness and surprise.

Optionally, the method further comprises outputting by the emotion recognising neural network an n-dimensional vector, wherein each component of the vector corresponds to one of the predetermined emotions, and a magnitude of each component of the vector corresponds to a confidence with which the emotion recognising neural network has recognised the emotion.

Optionally, the method comprises generating further output data corresponding to the n-dimensional vector associated with emotion.

Optionally, the facial mid-level feature metric of the human face is estimated based on an image recognition algorithm.

Optionally, the facial mid-level feature metric is one or more of gaze, head position and eye closure.

Optionally, the Long-Short-Term-Memory network is trained from video data classified to contain human faces associated with one or more of the plurality of the predetermined human characteristics.

Optionally, the human characteristic recognising neural network is a recurrent neural network.

Optionally, the human characteristic recognising neural network is a Long Short-Term Memory network.

Optionally, the human characteristic recognising neural network is a convolutional neural network.

Optionally, the human characteristic recognising neural network is a WaveNet based neural network.

Optionally, the output data of the human characteristic recognising neural network comprises an n-dimensional vector, wherein each component of the vector corresponds to a human characteristic, and a magnitude of each component of the vector corresponds to an intensity with which that characteristic is detected.

Optionally, the plurality of predetermined characteristics includes one or more of passion, confidence, honesty, nervousness, curiosity, judgment and disagreement.

In accordance with a second aspect of the disclosure, there is provided a system for recognising human characteristics from image data of a subject. The system comprises an input unit, an output unit, a processor and memory. The memory has stored thereon processor executable instructions which when executed on the processor control the processor to receive as input, via the input unit, image data; extract a sequence of images of a subject from the image data; from each image estimate an emotion feature metric (which is typically a lower dimensional feature vector from a CNN) and a facial mid-level feature metric for the subject; for each image, combine the associated estimated emotion metric and estimated facial midlevel feature metric to form a feature vector, to thereby form a sequence of feature vectors, each feature vector associated with an image of the sequence of images; process the sequence of feature vectors through a human characteristic recognising neural network adapted to generate output data corresponding to at least one human characteristic derived from the sequence of feature vectors. The output unit is adapted to output the output data generated by the neural network.

Optionally, the image data is video data.

Optionally, the extracted sequence of images are facial images of a face of the subject.

Optionally, the face of the subject is a human face.

Optionally, the processor executable instructions further control the processor to estimate the emotion metric using an emotion recognising neural network trained to recognise a plurality of predetermined emotions from images of human faces.

Optionally, the emotion metric is associated with a human emotion of one or more of anger, contempt, disgust, fear, happiness, sadness and surprise.

Optionally, the processor executable instructions further control the processor to output by the emotion recognising neural network an n-dimensional vector, wherein each component of the vector corresponds to one of the predetermined emotions, and a magnitude of each component of the vector corresponds to a confidence with which the emotion recognising neural network has recognised the emotion.

Optionally, the output unit is adapted to output the n-dimensional vector associated with emotion.

Optionally, the facial mid-level feature metric of the human face is estimated based on an image recognition algorithm.

Optionally, the facial mid-level feature metric is one or more of gaze, head position and eye closure.

Optionally, the Long-Short-Term-Memory network is trained from video data classified to contain human faces associated with one or more of the plurality of the predetermined human characteristics.

Optionally, the human characteristic recognising neural network is a recurrent neural network.

Optionally, the human characteristic recognising neural network is a Long Short-Term Memory network.

Optionally, the human characteristic recognising neural network is a convolutional neural network.

Optionally, the human characteristic recognising neural network is a WaveNet based neural network.

Optionally, the neural network is a combination of a convolutional neural network and a Long-Short-Term-Memory network.

Optionally, the output data of the human characteristic recognising neural network comprises an n-dimensional vector, wherein each component of the vector corresponds to a human characteristic, and a magnitude of each component of the vector corresponds to an intensity with which that characteristic is detected.

Optionally, the plurality of predetermined characteristics includes one or more of passion, confidence, honesty, nervousness, curiosity, judgment and disagreement.

In accordance with a third aspect of the disclosure, there is provided a computer program comprising computer readable instructions which when executed on a suitable computer processor controls the computer processor to perform a method according to the first aspect of the disclosure.

In accordance with a fourth aspect of the disclosure, there is provided a computer program product on which is stored a computer program according to the third aspect.

In accordance with embodiments of the disclosure, a process for recognising human characteristics is provided. The characteristics include personality traits such as passion, confidence, honesty, nervousness, curiosity, judgment and disagreement. These characteristics are not readily detected using conventional techniques which are typically restricted to identifying more immediate and obvious emotions such as anger, contempt, disgust, fear, happiness, sadness and surprise.

Combining a sequence of estimated emotion feature metrics with a corresponding sequence of estimated facial mid-level features metrics derived from, for example, video data of a subject, and then processing a resultant sequence of feature vectors through a suitably trained neural network provides a particularly effective technique for recognising human characteristics.

In certain embodiments, the process is arranged to recognise human characteristics from footage of one or more subjects (typically human faces) present in video data.

Various features and aspects of the disclosure are defined in the claims.

### BRIEF DESCRIPTION OF THE DRAWINGS

Embodiments of the present disclosure will now be described by way of example only with reference to the accompanying drawings where like parts are provided with corresponding reference numerals and in which:

FIG. 1 provides a diagram depicting facial tracking in accordance with the MTCNN model;

FIG. 2 provides a diagram showing a facial image before cropping, transforming, rescaling and normalising processes have been performed;

FIG. 3 provides a diagram showing the facial image of FIG. 2 after cropping, transforming, rescaling and normalising processes have been performed;

FIG. 4 provides a schematic diagram providing a simplified summary of exemplary architecture of an emotion recognising convolutional neural network suitable for use in embodiments of the disclosure;

FIG. 5 depicts pupil detection in an image;

FIG. 6 depicts head pose detection;

FIG. 7 provides a schematic diagram depicting processing stages and various steps 20 of a human characteristics recognising process in accordance with certain embodiments of the disclosure, and

FIG. 8 provides a simplified schematic diagram of a system adapted to perform a human characteristic recognising process in accordance with certain embodiments of the disclosure.

### DETAILED DESCRIPTION

In accordance with embodiments of the disclosure, a process for recognising human characteristics is provided. In certain embodiments, the process comprises a first stage, a second stage and a third stage.

First Stage

In the first stage, image processing is undertaken. In certain embodiments, the image processing stage comprises six steps.

At a first step, input video data is subject to a face detection process. As part of this process, the video is analysed, frame-by-frame, and for each frame, faces of one or more human subjects are detected. In one embodiment, a specifically adapted convolutional neural network (CNN) is used for this step. The CNN is adapted to identify regions of an image (e.g. a video frame) that are considered likely to correspond to a human face. An example of a suitable CNN is the MTCNN (Multi Task Cascaded Convolutional Neural Network) model: (https://github.com/davidsandberg/facenet/tree/master/src/align).

The output of this first face detection process step is a series of regions of interest. Each region of interest corresponds to a region of a video frame that the CNN determines are likely to correspond to a human face.

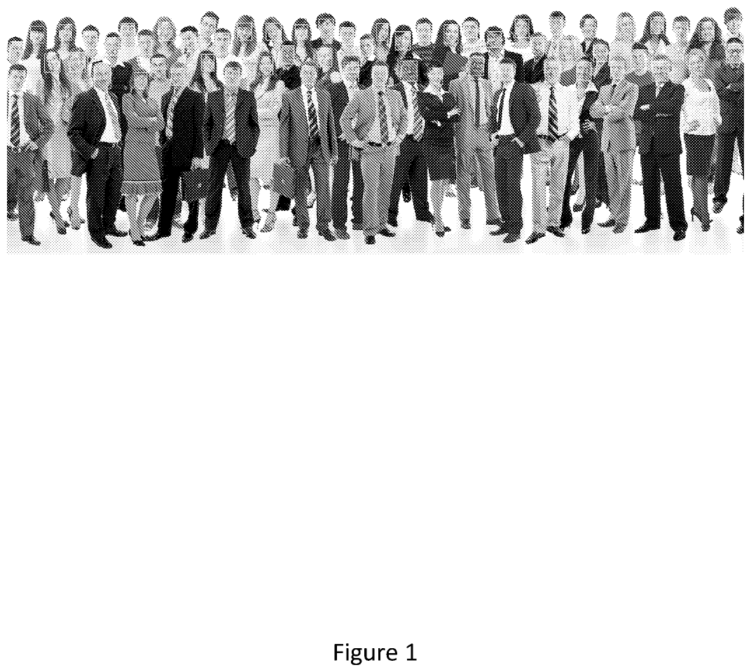

FIG. 1 provides a diagram depicting facial tracking in accordance with the MTCNN model.

At a second step, for each region of interest identified in the first step, a cropping process is undertaken where areas of the video frame not within a region of interest are cropped. A “bounding box” is used with an additional margin to increase the chance that most or all of the part of the frame containing the face is retained. In this way, a sequence of images of a likely human face are extracted.

The output of the second cropping process step is a series of cropped images, each cropped image corresponding to a likely human face.

At a third step, each cropped facial image is subject to a transformation process in which facial landmarks are detected. In certain examples, five facial landmarks are detected, namely both eyes, both lip corners and the nose tip. The distribution of the facial landmarks is then used to detect and remove head rotation. This is achieved using suitable transformation techniques such as affine transformation techniques.

The output of the third transformation process step is a cropped and transformed facial image.

At a fourth step, each cropped and transformed facial image is subject to a rescaling process in which each cropped and transformed image is rescaled to a predetermined resolution. An example predetermined resolution is 224 by 224 pixels.

In situations in which the cropped facial image is of a higher resolution than the predetermined resolution, the cropped and transformed facial image is downscaled using appropriate image downscaling techniques. In situations in which the cropped and transformed facial image is of a lower resolution than the predetermined resolution, the cropped and transformed facial image is upscaled using appropriate image upscaling techniques.

The output of the fourth rescaling process step is a cropped, transformed and rescaled facial image.

At a fifth step, the colour space of the cropped, transformed and rescaled facial image is transformed to remove redundant colour data, for example by transforming the image to greyscale.

The output of the fifth greyscale-transformation step is thus a cropped, transformed and rescaled facial image transformed to greyscale.

Finally, at sixth step an image normalisation process is applied to increase the dynamic range of the image, thereby increasing the contrast of the image. This process highlights the edge of the face which typically improves performance of expression recognition.

The output of the sixth step is thus a cropped, transformed and rescaled facial image transformed to greyscale and subject to contrast-enhancing normalisation.

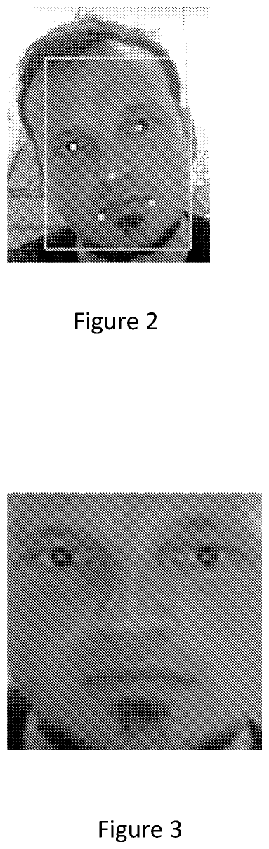

FIG. 2 provides a diagram showing a facial image before cropping, transforming, rescaling and normalising, and FIG. 3 provides a diagram showing the same facial image after cropping, transforming, rescaling transforming to grey scale and normalising.

Second Stage

The second stage comprises two feature estimation processes namely an emotion feature estimation process and a facial mid-level feature estimation process. Each feature estimation process estimates a feature metric from the facial image. The emotion feature estimation process estimates an emotion feature metric using pixel intensity values of the cropped image and the facial mid-level feature estimation process estimates a facial “mid-level” feature metric from the facial image.

Typically, both of processes run in parallel but independently of each other. That is both feature estimation processes process data corresponding to the same region of interest from the same video frame.

The emotion estimation feature process receives as an output from the sixth step of the first stage, i.e. the cropped, transformed and rescaled facial image transformed to greyscale and subject to contrast-enhancing normalisation. The facial mid-level feature estimation process receives as an input from the output of the second step of the first stage, i.e. the cropped facial image.

Emotion Feature Metric Estimation

The emotion feature metric process uses an emotion recognising CNN trained to recognise human emotions from facial images. Typically, the emotion recognising CNN is trained to identify one of seven human emotional states, namely anger, contempt, disgust, fear, happiness, sadness and surprise. This emotion recognising CNN is also trained to recognise a neutral emotional state. The emotion recognising CNN is trained using neural network training techniques, for example, in which multiple sets of training data with known values (e.g. images with human subjects displaying, via facial expressions, at least one of the predetermined emotions) are passed through the CNN undertaking training, and parameters (weights) of the CNN are iteratively modified to reduce an output error function.

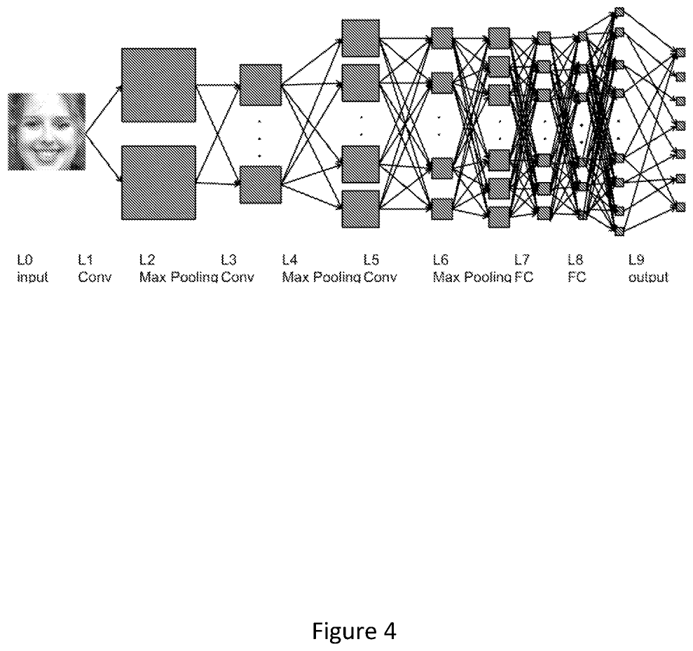

FIG. 4 provides a schematic diagram providing a simplified summary of exemplary architecture of an emotion recognising CNN suitable for use in embodiments of the disclosure. As can be seen from FIG. 4, the CNN comprises 10 layers: an initial input layer (L0); a first convolutional layer (L1), a first pooling layer using max pooling (L2); a second convolutional layer (L3); a second pooling layer using max pooling (L4); a third convolutional layer (L5); a third pooling layer using max pooling (L6); a first fully connected layer (L7); a second fully connected layer (L8) and finally an output layer (L9).

As will be understood, the architecture depicted in FIG. 4 is exemplary, and alternative suitable architectures could be used.

The output of the emotion feature metric process is, for each input facial image, an n-dimensional vector. Each component of the n-dimensional vector corresponds to one of the emotions that the CNN is adapted to detect. In certain embodiments, the n-dimensional vector is an eight-dimensional vector and each component corresponds to one of anger, contempt, disgust, fear, happiness, sadness, surprise and neutral.

The value of each of the eight vector components corresponds to a probability value and has a value within a defined range, for example between 0 and 1. The magnitude of a given vector component corresponds to the CNN's confidence that the emotion to which that vector component corresponds is present in the facial image. For example, if the vector component corresponding to anger has a value of 0, the CNN has the highest degree of confidence that the face of the subject in the facial image is not expressing anger. If the vector component corresponding to anger has a value of 1, the CNN has the highest degree of confidence that the face of the subject in the facial image is expressing anger. If the vector component corresponding to anger has a value of 0.5, the CNN is uncertain whether the face of the subject in the facial image is expressing anger or not.

Facial Mid-Level Feature Metric Estimation

The facial mid-level feature metric estimation process detects these facial mid-level features using suitable facial image recognition techniques which are known in the art. For example, the facial mid-level feature metric estimation process comprises an action detector imaging processing algorithm which is arranged to detect mid-level facial features such as head pose (e.g. head up, head down, head swivelled left, head swivelled right, head tilted left, head tilted right); gaze direction (e.g. gaze centre, gaze up, gaze down, gaze left, gaze right), and eye closure (e.g. eyes open, eyes closed, eyes partially open). The action detector imaging processing algorithm comprises a “detector” for each relevant facial mid-level feature e.g. a head pose detector, gaze direction detector, and eye closure detector.

As described above, typically, the action detector imaging processing algorithm takes as an input the output of the second step of the first stage, i.e. a cropped facial image that has not undergone the subsequent transforming, rescaling and normalising process (e.g. the image as depicted in FIG. 2).

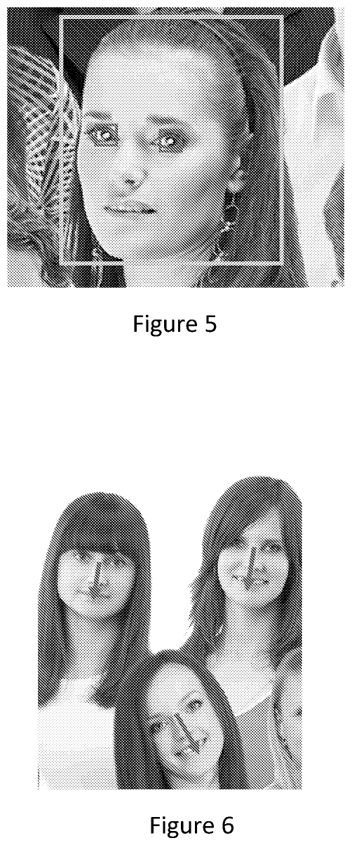

FIG. 5 depicts pupil detection which can be used to detect eye closure and gaze direction in the gaze direction detector and eye closure detector parts of the action detector imaging processing algorithm.

FIG. 6 depicts head pose detection. A suitable head pose detection process which can be used in the head pose detector part of the action detector imaging processing algorithm comprises identifying a predetermined number of facial landmarks (e.g. 68 predetermined facial landmarks, including for example, 5 landmarks on the nose) which are input to a regressor (i.e. a regression algorithm) with multiple outputs. Each output corresponds to one coordinate of a head pose.

The output of the facial mid-level feature metric estimation process is a series of probabilistic values corresponding to a confidence level of the algorithm that the facial mid-level feature in question has been detected. For example, the eye closure detector part of the action detector imaging processing algorithm that predicts if one eye is open or close (binary) has two outputs. P_(eye_close) and P_(eye_open) and the outputs sum up to one.

Third Stage

The third stage involves the use of a neural network trained to recognise human characteristics.

The human characteristic recognising neural network can be provided by a suitably trained convolutional neural network or suitably trained convolutional recurrent neural network. In certain embodiments, the human characteristic recognising neural network is provided by an optimised and trained version of “WaveNet”, a deep convolutional neural network provided by DeepMind Technologies Ltd.

In other embodiments, the human characteristic recognising neural network can be provided by a suitably trained convolutional neural network such as a Long Short-Term Memory (LSTM) network.

Initially, the output of both the emotion feature metric estimation and the facial midlevel feature metric estimation are combined to form a single feature vector. Typically, another suitably trained, neural network, specifically, a one-dimensional neural network, is used to perform this step and generate the feature vector. A suitable one-dimensional recurrent neural network, such as a Long Short-Term Memory (LSTM) network may typically be used as the feature vector generating neural network.

Accordingly, a feature vector is provided for each face detected in each frame of the video data.

Feature vectors, corresponding to each image, are input to the human characteristic recognising neural network. The human characteristic recognising neural network has been trained to recognise human characteristics from a series of training input feature vectors derived as described above.

Once every feature vector derived from the input video data has been input to the human characteristic recognising neural network, an output is generated. The output of the human characteristic recognising neural network is a characteristic classification which may be one of passion, confidence, honesty, nervousness, curiosity, judgment and disagreement. In certain embodiments, the output of the human characteristic recognising neural network is an n-dimensional vector, where N is the number of characteristics being recognised. Each component of the n-dimensional vector corresponds to a characteristic.

Typically, the magnitude of each component of the n-dimensional vector, rather than corresponding to a confidence value, corresponds to an intensity value, i.e. the intensity of that characteristic recognised by the human characteristic recognising neural network as being present in the subject of the images. In certain embodiments, the magnitude of each component of the vector is between 0 and 100.

In certain embodiments, the process is adapted to also output an emotion classification, i.e. a vector indicative of one or more of anger, contempt, disgust, fear, happiness, sadness and surprise. In such embodiments, the emotion classification is typically generated directly from the output of the emotion recognising convolutional neural network.

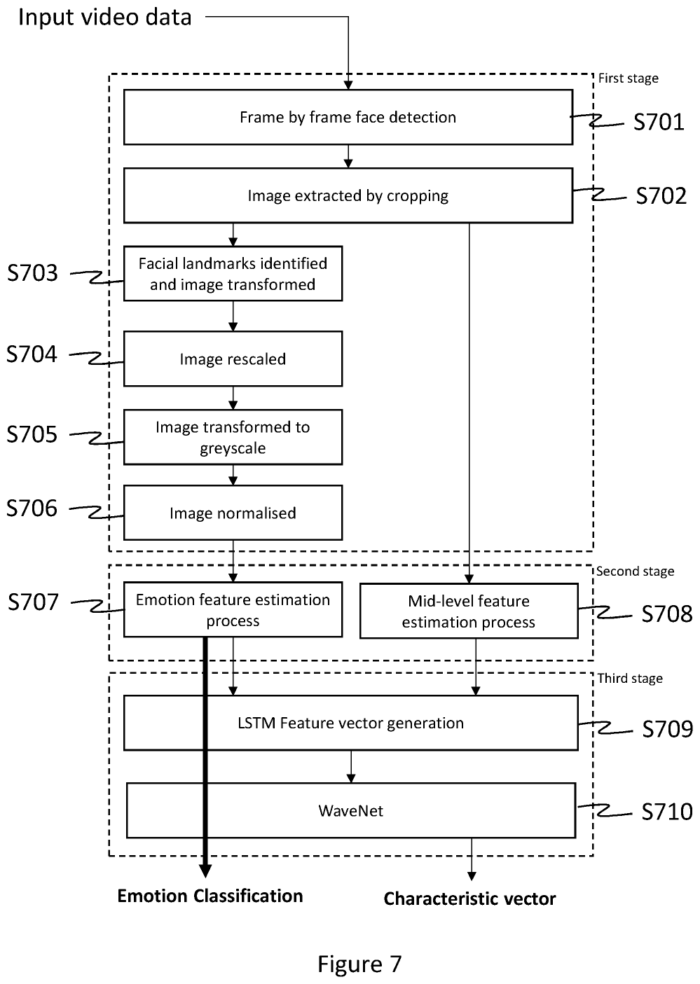

FIG. 7 provides a schematic diagram depicting processing stages of a human characteristics recognising process in accordance with certain embodiments of the disclosure.

At a first step S701, for input video data a face detection process is performed, frame-by-frame. At a second step S702 for each region of interest identified in the first step S701, a facial image is generated by cropping the region of interest from the original frame. At a third step S703 facial landmarks are identified and the image is transformed to reduce the effect of head rotation. At a fourth step S704 the image is rescaled. At a fifth step S705 the image is transformed to greyscale. At a sixth step S706 the image is normalised to enhance contrast. At seventh step S707 images output from the sixth step S706 are input to an emotion feature estimation process. In parallel to the seventh step S707, at an eighth step S708, output from the second step S702 are input to a facial mid-level features estimation process. At a ninth step S709, output from the seventh step S707 and eighth step S708 are input to a feature vector generation process, provided, for example, by a suitable trained feature vector generating one-dimensional neural network. At a tenth step S710, feature vectors generated by the ninth step S709 are input to a human characteristic recognising neural network (provided for example by a convolutional neural network such as an optimised and trained WaveNet based neural network or by a recurrent neural network such as an LSTM network). When a number of feature vectors have been input to the characteristic recognising neural network (typically corresponding to the number of regions of interest detected across the video frames of which the video data comprises), a characteristic vector is output.

In certain embodiments, an emotion classification is also output. The emotion classification is typically generated as a direct output from the seventh step.

As can be appreciated with reference to FIG. 7, an input to the process described above is video data and the output is output data corresponding to at least one human characteristic derived by a human characteristic recognising neural network (e.g. a WaveNet based network or an LSTM network) from a sequence of feature vectors. The process includes extracting a sequence of images of a human face from video data. As described above, this typically comprises identifying for each frame of the video data, one or more regions of interest considered likely to correspond to a human face and extracting an image of the region of interest by cropping it from the frame. The extracted (e.g. cropped) images are then used to estimate a facial mid-level feature metric and an emotion feature metric for corresponding images (i.e. images based on the same region of interest from the same video frame). As described above, typically, before the emotion feature metric is estimated, the cropped image undergoes a number of further image processing steps.

For each corresponding image, a feature vector is generated from the facial mid-level feature metric and emotion feature metric.

As mentioned above, typically an appropriately trained/optimised recurrent neural network, such as a one-dimensional LSTM, is used to generate the feature vector from the facial mid-level feature metric and the emotion feature metric. This neural network can be adapted to perform a smoothing function on the output of the emotion feature estimation process and the mid-level facial features estimation process.

Accordingly, for video data including footage of human faces, a sequence of feature vectors will be generated as each frame is processed. This sequence of feature vectors is input to a human characteristic recognising neural network. The sequence of feature vectors are processed by the human characteristic recognising neural network and output data corresponding to a recognised human characteristic (e.g. the n-dimensional vector described above).

As described above, the human characteristic recognising neural network is trained to recognise human characteristics based on input feature vectors derived from video data.

Typically, training of the human characteristic recognising neural network is undertaken using neural network training techniques. For example, during a training phase, multiple sets of training data with a known/desired output value (i.e. feature vectors derived from videos containing footage of a person or people known to be demonstrating a particular characteristic) are processed by the human characteristic recognising neural network. Parameters of the human characteristic recognising neural network are iteratively adapted to reduce an error function. This process is undertaken for each desired human characteristic to be measured and is repeated until the error function for each characteristic to be characterised (e.g. passion, confidence, honesty, nervousness, curiosity, judgment and disagreement) falls below a predetermined acceptable level.

Certain types of videos, which advantageously are readily identifiable and classifiable based on metadata associated with the nature of their content, have been identified and found to provide good training for the human characteristic recognising neural network. For example, the characteristic of “confidence” is often reliably associated with footage of a person speaking publicly, for example a person delivering a public presentation. Similarly, the characteristics of happiness and kindness are often reliably associated with footage of video bloggers and footage of interviewees for jobs (e.g. “video CVs”).

In certain embodiments, the human characteristic recognising neural network training data is generating by a two stage selection process. In a first stage, videos of a type usually associated with a particular human characteristic are selected (e.g. video footage of public speaking, video footage of video bloggers and video CVs). In a second stage, human experts “annotate” each video, i.e. classify the human characteristics shown in the video. Typically, at least two human experts are used to classify the videos. Videos in which the opinion of the human experts differ (e.g. one human expert classifies a video as “confident” and the other human expert classifies it as “nervous”) are rejected for training purposes.

In embodiments of the disclosure, the processing steps depicted in FIG. 7 can be manifested and undertaken in any suitable way.

The processing steps may be undertaken by a single software program or may be distributed across two or more software programs or modules. For example, one or more of the human characteristic recognising neural network, the face detection step, the emotion feature estimation process, the facial mid-level facial feature estimation process and the feature vector generation process may be provided by discrete software modules running independently of other parts of the software. The input video data may be received as input into the process via a suitable input application programming interface (API). The output generated by the process (e.g. the n-dimensional characteristic vector and the emotion classification) may be output to other processes/software running on the computing device on which the process is performed via a suitable output API. Aspects of the process (e.g. parameters of the rescaling step, the normalisation step) may be configurable via a suitable interface (e.g. a graphical user interface) provided to a user.

In certain embodiments, the processing steps depicted in FIG. 7 may be implemented in one or more specifically configured hardware units, for example specific processing cores for performing certain steps.

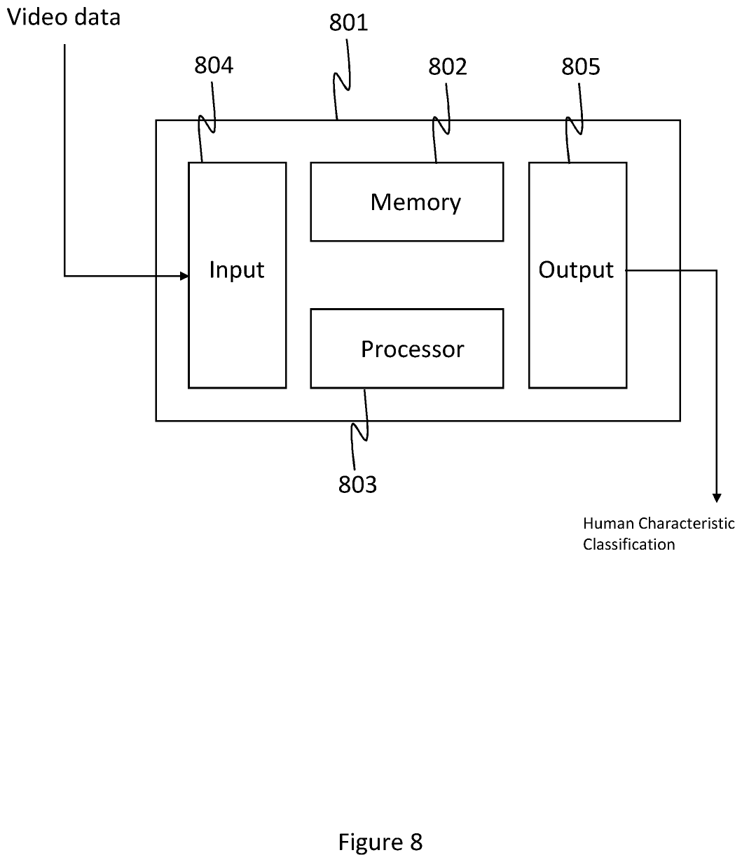

FIG. 8 provides a simplified schematic diagram of a system 801 adapted to perform the human characteristics recognition process described above in accordance with certain embodiments of the disclosure.

The system 801 comprises a memory unit 802 and a processor unit 803. The memory unit 802 has stored thereon a computer program comprising processor readable instructions which when performed on a processor, cause the processor to perform a human characteristics recognition process as described above.

The system 801 further comprises an input unit 804 adapted to receive video data. Video data received via the input unit 804 is processed by the processor unit 803 performing the human characteristics recognition process described above. The output of this process (e.g. an n-dimensional vector indicative of one or more recognised characteristics) is output by the system 801 via an output unit 805. In some implementations, the output (e.g. the n-dimensional vector) is output to the memory unit 802 for storage and subsequent processing.

The system depicted in FIG. 8 can be provided by any suitable computing device, for example a suitable personal computer a tablet or a “smart” device such as a smart phone. The specific nature of the components depicted in FIG. 8 will depend on the type of computing device of which the system comprises. For example, if the computing device is a personal computer, the processor and memory will be provided by processor hardware and memory hardware well known in the art for use in personal computers. Similarly, the input unit and output unit will comprise known hardware means (e.g. a data bus) to send and receive data from peripheral devices such as a connection interface with a data network, memory device drives and so on.

In certain embodiments, the processor unit 803 depicted in FIG. 8 is a logical designation and the functionality provided by the processor unit 803 is distributed across more than one processor, for example multiple processing cores in a multi-core processing device or across multiple processing units distributed in accordance with known distributed (“cloud”) computing techniques.

In one example, a human characteristic recognition system in accordance with embodiments of the disclosure can be used in a selection process. A system is provided in which video footage is captured, for example using a digital video camera, of a subject (e.g. an interviewee for a job) answering a number of predetermined interview questions. The video footage is stored as a video data file. Video footage of one or more further subjects is similarly captured of other subjects answering the same predetermined interview questions. Further video data files are thus generated and stored. Subsequently, each video data file is input to a computing device, for example a personal computer, comprising a memory on which is stored software for performing a human characteristic recognition process as described above. As will be understood, the computing device includes a processor on which the software is run, typically in conjunction with an operating system also stored in the memory. The video data files can be transferred to the computing in any suitable way, for example via a data network connection, or by transferring a memory device, such as a memory card from a memory device drive of the video capture device to a suitable memory device drive of the computing device.

For each video data file, a corresponding n-dimensional characteristic vector is generated as described above. The software stored on the memory and running on the processor may implement further output functionality. For example, a ranking process may be implemented in which, based on the n-dimensional characteristic vector generated for each video file, each subject is ranked. For example, the ranking process may comprise generating a preference metric for each subject. The preference metric may be the sum of values of selected characteristic components of the n-dimensional vector. For example, the preference metric could be the sum of the components of the component of the n-dimensional vector corresponding to confidence and honesty. A preference metric can thus be generated for each subject, and each subject ranked based on the value of the preference metric. This ranking process readily enables a user of the system to identify subjects with the highest levels of characteristics that are deemed desirable.

As will be understood, typically, the software also controls the computing device to provide a user interface allowing a user to control aspects of the process provided by the software, for example select video data files for processing, define preference metrics, and on which an output of the human characteristic recognition process is displayed, for example graphical and/or numerical representations of the output n-dimensional vector and graphical and/or numerical representations of the ranking process.

As will be understood, aspects of the disclosure may be implemented in the form of a computer program product comprising instructions (i.e. a computer program) that may be implemented on a processor, stored on a data sub-carrier such as a floppy disk, optical disk, hard disk, PROM, RAM, flash memory or any combination of these or other storage media, or transmitted via data signals on a network such as an Ethernet, a wireless network, the Internet, or any combination of these of other networks, or realised in hardware as an ASIC (application specific integrated circuit) or an FPGA (field programmable gate array) or other configurable or bespoke circuit suitable to use in adapting the conventional equivalent device.

Attention is directed to all papers and documents which are filed concurrently with or previous to this specification in connection with this application and which are open to public inspection with this specification, and the contents of all such papers and documents are incorporated herein by reference. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The disclosure is not restricted to the details of the foregoing embodiment(s). The disclosure extends to any novel one, or any novel combination, of the features disclosed in this specification (including any accompanying claims, abstract and drawings), or to any novel one, or any novel combination, of the steps of any method or process so disclosed.

1. A method of recognising human characteristics from image data of a subject, said method comprising:
extracting a sequence of images of the subject from the image data;
from each image estimating an emotion feature metric and a facial mid-level feature metric for the subject;
for each image, combining the associated estimated emotion metric and estimated facial mid-level feature metric to form a feature vector, thereby forming a sequence of feature vectors, each feature vector associated with an image of the sequence of images; and
inputting the sequence of feature vectors to a human characteristic recognising neural network, wherein
said human characteristic recognising neural network is adapted to process the sequence of feature vectors and generate output data corresponding to at least one human characteristic derived from the sequence of feature vectors.

2. A method according to claim 1, wherein the image data is video data, the extracted sequence of images are facial images of a face of the subject, and the face of the subject is a human face.

3. (canceled)

4. (canceled)

5. A method according to claim 2, wherein the emotion metric is estimated by an emotion recognising neural network trained to recognise a plurality of predetermined emotions from images of human faces.

6. A method according to claim 5, wherein the emotion metric is associated with a human emotion of one or more of anger, contempt, disgust, fear, happiness, sadness and surprise.

7. A method according to claim 5, comprising outputting by the emotion recognising neural network an n-dimensional vector, wherein each component of the vector corresponds to one of the predetermined emotions, and a magnitude of each component of the vector corresponds to a confidence with which the emotion recognising neural network has recognised the emotion.

8. A method according to claim 7, comprising generating further output data corresponding to the n-dimensional vector associated with emotion.

9. A method according to claim 1, wherein the facial mid-level feature metric of the human face is estimated based on an image recognition algorithm, and the facial mid-level feature metric is one or more of gaze, head position and eye closure.

10. (canceled)

11. A method according to claim 1, wherein the human characteristic recognising neural network is trained from video data classified to contain human faces associated with one or more of the plurality of the predetermined human characteristics.

12. A method according to claim 1, wherein the human characteristic recognising neural network is a recurrent neural network.

13. A method according to claim 12, wherein the human characteristic recognising neural network is a Long Short-Term Memory network.

14. A method according to claim 1, wherein the human characteristic recognising neural network is a convolutional neural network.

15. A method according to claim 14, wherein the human characteristic recognising neural network is a WaveNet based neural network.

16. A method according to claim 1, wherein the output data of the human characteristic recognising neural network comprises an n-dimensional vector, wherein each component of the vector corresponds to a human characteristic, and a magnitude of each component of the vector corresponds to an intensity with which that characteristic is detected.

17. A method according to claim 1, wherein the plurality of predetermined characteristics includes one or more of passion, confidence, honesty, nervousness, curiosity, judgment and disagreement.

18. A system for recognising human characteristics from image data of a subject, said system comprising an input unit, an output unit, a processor and memory, wherein said memory has stored thereon processor executable instructions which when executed on the processor control the processor to
receive as input, via the input unit, image data;
extract a sequence of images of a subject from the image data;
from each image estimate an emotion feature metric and a facial mid-level feature metric for the subject;
for each image, combine the associated estimated emotion metric and estimated facial mid-level feature metric to form a feature vector, to thereby form a sequence of feature vectors, each feature vector associated with an image of the sequence of images;
process the sequence of feature vectors through a human characteristic recognising neural network adapted to generate output data corresponding to at least one human characteristic derived from the sequence of feature vectors, and
the output unit is adapted to output the output data generated by the neural network.

19. A system according to claim 18, wherein the image data is video data, the extracted sequence of images are facial images of a face of the subject, and the face of the subject is a human face.

20. (canceled)

21. (canceled)

22. A system according to claim 19, wherein the processor executable instructions further control the processor to estimate the emotion metric using an emotion recognising neural network trained to recognise a plurality of predetermined emotions from images of human faces.

23. A system according to claim 22, wherein the emotion metric is associated with a human emotion of one or more of anger, contempt, disgust, fear, happiness, sadness and surprise

24. A system according to claim 22, wherein the processor executable instructions further control the processor to output by the emotion recognising neural network an n-dimensional vector, wherein each component of the vector corresponds to one of the predetermined emotions, and a magnitude of each component of the vector corresponds to a confidence with which the emotion recognising neural network has recognised the emotion; wherein the output unit is adapted to output the n-dimensional vector associated with emotion.

25. (canceled)

26. (canceled)

27. (canceled)

28. (canceled)

29. (canceled)

30. (canceled)

31. (canceled)

32. (canceled)

33. (canceled)

34. (canceled)

35. A non-transitory computer readable storage medium, comprising computer readable instructions stored thereon, wherein the computer readable instructions, when executed on a suitable computer processor, control the computer processor to perform a method according to claim 1.

36. (canceled)
